(19) United States
(12) Patent Application Publication
(10) Pub. No.: US 2007/0296768 A1
(43) Pub. Date: Dec. 27, 2007

(54) Print head and fabrication method thereof

(75) Inventors: Jae-sik Min, Suwon-si (KR); You-seop Lee, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/646,260

(22) Filed: Dec. 28, 2006

(30) Foreign Application Priority Data
Jun. 27, 2006 (KR) 2006-58224

(51) Int. Cl. B41J 2/05

(52) U.S. Cl. 347/63

(57) ABSTRACT

A printer head is provided that enhances energy efficiency of a heater layer and substantially prevents heat from being excessively transmitted to ink in an ink chamber, thereby improving ink-ejecting performance and/or printing performance. A method of fabricating such a printer head is also provided. The print head includes a substrate having an ink chamber and a nozzle disposed in the top thereof, an insulating layer layered on the substrate, and a heater layer layered on the insulating layer. A heat transmitting part transmits heat to the ink chamber. The insulating layer is formed so that a portion thereof that faces the heat transmitting part of the heater layer has a thickness larger than that of the rest of the insulating layer.

### CROSS-REFERENCE TO RELATED APPLICATION

This application claims the benefit under 35 U.S.C. § 119(a) of Korean Patent Application No. 10-2006-58224, filed Jun. 27, 2006, in the Korean Intellectual Property Office, the entire disclosure of which is hereby incorporated by reference.

### BACKGROUND OF THE INVENTION

1. Field of the Invention

The present invention relates to an inkjet printer. More particularly, the present invention relates to an inkjet print head that ejects ink onto a recording medium.

2. Description of the Related Art

Generally, an inkjet printer, as an apparatus to eject ink onto a desired position of a recording medium to form a desired image, includes an ink cartridge.

The ink cartridge is provided with a cartridge body having a containing space to contain foam and/or ink therein, and a print head disposed at a side of a supplying channel of the cartridge body. The print head has more than one nozzle through which ink is supplied from the cartridge body.

According to an ink-ejecting mechanism, the print head is classified into a thermal driving type head and a piezoelectric driving type head. The thermal driving type head uses heat generated from a heating source, such as a heater and the like, to produce bubbles in ink and thus to eject the ink by an expansive force of the bubbles. The piezoelectric driving type head uses a piezoelectric element to eject ink with a distortion of the piezoelectric element.

FIG. 1 shows a conventional thermal driving type print head. The print head 10 includes a substrate 11, a chamber layer 20 layered on the substrate 11 to define an ink chamber 22, and a nozzle plate 30 layered on the chamber layer 20. The ink chamber 22 is filled with ink. Below the ink chamber 22 is disposed a heater layer 13 for producing bubbles in the ink. The nozzle plate 30 has more than one nozzle 32 to eject the ink.

Referring to a structure of the print head 10 layered under the ink chamber 22, an insulating layer 12, a heater layer 13, a wire layer 14 to apply an electric current to the heater layer 13, a protecting layer 15 to protect the heater layer 13 and the wire layer 14, and a cavitation preventing layer 16 are layered in turn on the substrate 11 of silicon material.

The insulating layer 12 is formed by depositing a silicon oxide SiO₂ on the substrate 11. The insulating layer 12 insulates the substrate 11 from the heater layer 13, so that heat generated by the heater layer 13 is blocked from being transmitted to the substrate 11. Accordingly, the heat of the heater layer 13 is more efficiently transmitted to the ink chamber 22.

The heater layer 13 is formed of a heating element containing Tantalum (Ta), such as TaN, TaAl, and so forth.

The wire layer 14 is formed of a metallic material with a good conductivity, such as Aluminum (Al) and the like.

The protecting layer 15 prevents the heater layer 13 and the wire layer 14 from being oxidized or being in direct contact with the ink, and is formed mainly by depositing a silicon nitride SiNx.

Recently, print head technology is moving in a direction in which print heads are driven at a high speed and at a lower electric power and integrated in a large scale, as in an array head or a line head.

For print heads to be driven at high speeds and at lower electric power and to be integrated in a large scale, it essentially requires that the efficiency of the heater layer 13 described above should be increased. As a method of raising the efficiency of the heater layer 13, there is a method of increasing a resistance or a thickness of the heater layer 13.

If the thickness of the heater layer 13 is increased, an insulating efficiency is increased, so that an input energy (that is, an electric energy) inputted into the heater layer 13 can be reduced. As a result, the efficiency of the heater layer 13 is increased.

However, as the thickness of the heater layer 13 is increased, the heat of the heater layer 13 can be excessively transmitted to the ink in the ink chamber 22. As a result, the ink in the ink chamber 22 is overheated, so that it does not maintain a viscosity adapted to eject the ink, thereby resulting in a deterioration of ink-ejecting performance and/or printing performance.

Accordingly, a need exists for an improved printer head in which the ink-ejecting and printing performances are not substantially deteriorated.

### SUMMARY OF THE INVENTION

An aspect of an exemplary embodiment of the present invention is to provide a printer head capable of improving ink-ejecting performance and/or printing performance, and a fabrication method thereof.

Another aspect of the present invention is to provide a printer head capable of enhancing an energy efficiency of a heater layer and substantially preventing heat from being excessively transmitted to ink in an ink chamber, and a fabrication method thereof.

According to an aspect of an exemplary embodiment of the present invention, a print head includes a substrate having an ink chamber and a nozzle disposed in the top thereof, an insulating layer layered on the substrate, and a heater layer layered on the insulating layer, and having a heat transmitting part to transmit heat to the ink chamber. The insulating layer has an uneven thickness.

The insulating layer may be formed so that a portion thereof facing the heat transmitting part has a thickness larger than the rest of the insulating layer.

The heater layer may be formed so that the heat transmitting part has a height different from that of the other portion of the heater layer.

The heater layer may be formed so that the heat transmitting part has the same height as that of the other portion of the heater layer.

The insulating layer may have a raised floor formed on a portion thereof that faces the heat transmitting part.

According to another aspect of an exemplary embodiment of the present invention, a print head includes a substrate, a chamber layer disposed at the upper side of the substrate, an ink chamber, an insulating layer layered on the substrate, a heater layer layered on the insulating layer, a heat transmitting part, a wire layer layered on the heater layer to apply current to the heater layer, and a protecting layer layered on the wire layer and the heater layer. The insulating layer has an uneven thickness.

The insulating layer may be formed so that a portion thereof that faces the heat transmitting part has a thickness larger than that of the rest of the insulating layer.

The heater layer may be formed so that the heat transmitting part has a height different from that of the other portion of the heater layer.

The heater layer may be formed so that the heat transmitting part has the same height as that of the other portion of the heater layer.

The insulating layer may have a raised floor formed on a portion thereof that faces the heat transmitting part.

According to another aspect of an exemplary embodiment of the present invention, a fabrication method of a print head includes forming a heater layer on an insulating layer with an uneven thickness after forming the insulating layer on a substrate.

The insulating layer may be formed so that a portion thereof that faces a heat transmitting part of the heater layer has a thickness larger than that of the rest of the insulating layer.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is an elevational view in cross section of a conventional print head;

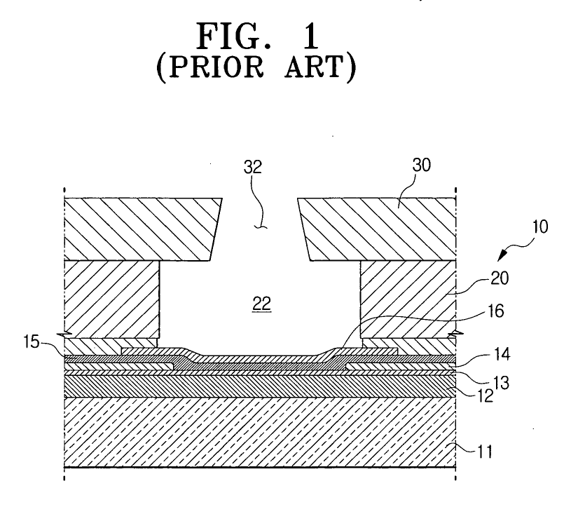

FIG. 2 is an elevational view in cross section view of a lower structure of a print head in accordance with an exemplary embodiment of the present invention;

FIG. 3 is an elevational view in cross section of a lower structure of a print head in accordance with another exemplary embodiment of the present invention; and

FIG. 4 is a graph exemplifying a comparison result between a mean temperature of bulk ink in the print head according to an exemplary embodiment of the present invention and that in the conventional print head.

Throughout the drawings, the same drawing reference numerals will be understood to refer to the same elements, features, and structures.

### DETAILED DESCRIPTION OF EXEMPLARY EMBODIMENTS

The matters defined in the description, such as a detailed construction and elements thereof, are provided to assist in a comprehensive understanding of the exemplary embodiments of the invention. Accordingly, those of ordinary skill in the art will recognize that various changes and modifications of the exemplary embodiments described herein may be made without departing from the scope and spirit of the invention. Also, descriptions of well-known functions and constructions are omitted for clarity and conciseness.

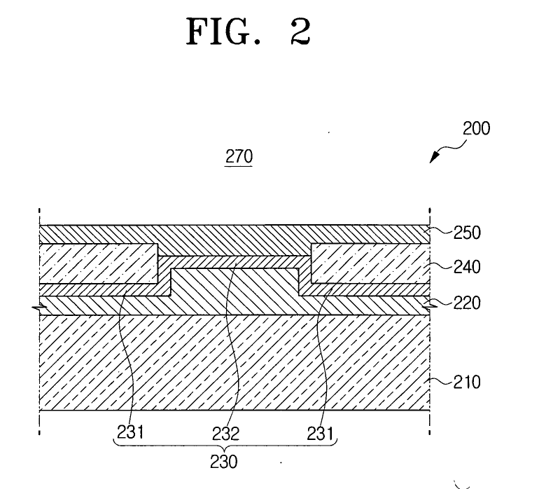

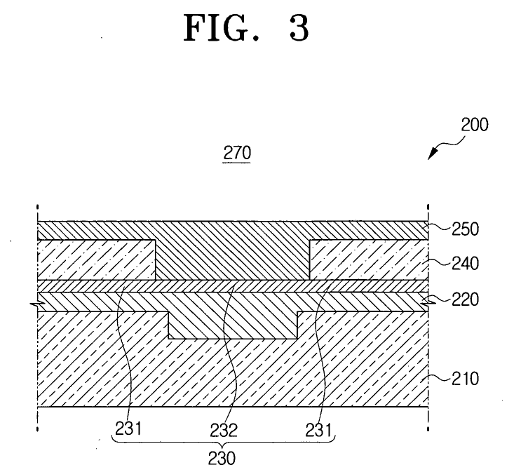

Referring to FIG. 2 and/or FIG. 3 exemplifying print heads in accordance with exemplary embodiments of the present invention, a print head 200 includes a substrate 210, an insulating layer 220, a heater layer 230, a wire layer 240, and a protecting layer 250.

The substrate 210 may be formed by machining a silicon wafer, which is mainly used as a semiconductor element, to a thickness of approximately 400˜650 μm.

As illustrated in FIGS. 2 and 3, the insulating layer 220 is formed so that it has an uneven (or non-uniform) thickness. A portion of the insulating layer 220 that faces a heat transmitting part 232 of the heater layer 230, which is described later, has a thickness different from that of the other portion of the insulating layer 220.

Preferably, but not necessarily, the insulating layer 220 is formed so that the portion of the insulating layer 220 that faces the heat transmitting part 232 of the heater layer 230 has a thickness larger than that of the other portion of the insulating layer 220, thereby allowing heat generated from the heater layer 230 to be more efficiently transmitted into an ink chamber 270 and substantially blocking heat generated from the heater layer 230 from being transmitted to the substrate 210 from the heat transmitting part 232.

Additionally, the insulating layer 220 is formed so that a portion of the insulating layer 220 that faces a current applying part 231 of the heater layer 230, which is described later, has a thickness smaller than that of the portion of the insulating layer 220 that faces the heat transmitting part 232, thereby allowing a portion of the heat generated from the heater layer 230 to be radiated into the substrate 210 through the current applying part 231 of the heater layer 230.

That is, with the insulating layer 220 having the uneven thickness, the print head according to exemplary embodiments of the present invention substantially prevents heat from being excessively transmitted into the ink in the ink chamber 270, so that ink in the ink chamber 270 is not overheated. Accordingly, ink in the ink chamber 270 may maintain a viscosity adapted for ejection, thereby substantially preventing ink ejecting performance and printing performance from being deteriorated.

Such an insulating layer 220 may be formed in a shape illustrated in FIG. 2 by depositing an oxide, such as SiO₂, on an upper surface the substrate 210 or by oxidizing a portion of the upper surface of the substrate 210, and then patterning the deposited oxide or the oxidized portion with an etching method, such as a dry etching or a wet etching.

Additionally, the insulating layer 220 may be formed in a shape illustrated in FIG. 3 by oxidizing a portion of the upper surface of the substrate 210 with a sacrificing layer oxidization method.

The heater layer 230 is disposed on an upper surface of the insulating layer 220. The heater layer 230 has a current applying part 231 and a heat transmitting part 232. The current applying part 231 has a wire layer 240 (described below) layered on an upper surface thereof, so that it receives electric current through the wire layer 240. The heat transmitting part 232 does not have the wire layer 240 thereon, so that it transmits generated heat directly to the ink chamber 270.

The heater layer 230 may be configured so that, as illustrated in FIG. 2, the insulating layer 220 has uneven thickness, and the heat transmitting part 232 is positioned at a height above the current applying part 231. Alternatively, as illustrated in FIG. 3, the heat transmitting part 232 is positioned at a height identical to or similar to that of the current applying part 231.

Such a heater layer 230 may be formed by depositing a heat resistant material, such as TaN, TaAl, TiN or tungsten silicide, on an upper surface of the insulating layer 220, and then pattering the deposited heating resistant material.

The wire layer 240 is disposed on an upper surface of the current applying part 231 of the heater layer 230, and is made of a metal to apply the electric current to the heater layer 230.

Such a wire layer 240 is formed by depositing a metallic material having good conductivity, such as Al and the like, on a portion of an upper surface of the heater layer 230. A portion of the deposited metallic material that faces the heat transmitting part 232 of the heater layer 230 is then patterned with an etching method and the like.

The protecting layer 250 is disposed on upper surfaces of the wire layer 240 and the heater layer 230, and substantially prevents the wire layer 240 and the heat transmitting part 232 of the heater layer 230 from being oxidized or coming in contact with ink in the ink chamber 270.

Such a protecting layer 250 may be formed by depositing a silicon nitride SiN₄ and the like with a Plasma-enhanced chemical vapor deposition (PECVD) method.

Additionally, a cavitation prevention layer (not illustrated) may be formed on the protecting layer.

The following table 1 illustrates a plurality of characteristic values for forming bubbles, each of which is divided into that of the print head according to exemplary embodiments of the present invention and that of the conventional print head. The insulating layer 220 according to exemplary embodiments of the present invention was formed so that a portion thereof that faces the heat transmitting part 232 of the heater layer 230 has a thickness of 1.8 μm and the remaining portion thereof has a thickness of 0.3 μm.

TABLE 1

| | Exemplary embodiments | The conventional |
|---|---|---|
| Item | of the present invention | example |
| Pulse width (μs) | 0.6 | 0.6 |
| Amount of electric power | 2.0 | 2.0 |
| (W/m) | | |
| Time for till bubble comes | 0.78 | 0.78 |
| to maximum size (μs) | | |
| Inputted electric energy (μJ) | 1.2 | 1.2 |
| Tb (° C.) | 287.3 | 287.3 |
| Critical bubble forming | 7989 | 7990 |
| energy (μJ) | | |
| Temperature increasing rate | 2.1E+8 | 2.1E+8 |
| of heater for forming | | |
| bubbles (° C./sec) | | |

The inputted electric energy means an electric energy value inputted into the heater layer to form bubbles in ink. Tb means a surface temperature of the heater layer at a point of time when bubbles begin to form in the ink. The critical bubble forming energy means a minimum energy that is transmitted to the ink from the heater layer to form bubbles.

As illustrated in the above Table 1, it may be appreciated that in the print head according to exemplary embodiments of the present invention, the entire characteristic values including the inputted electric energy, and so forth, maintain almost unchanged as compared with those of the conventional print head, even though the insulating layer 220 was formed having an uneven thickness.

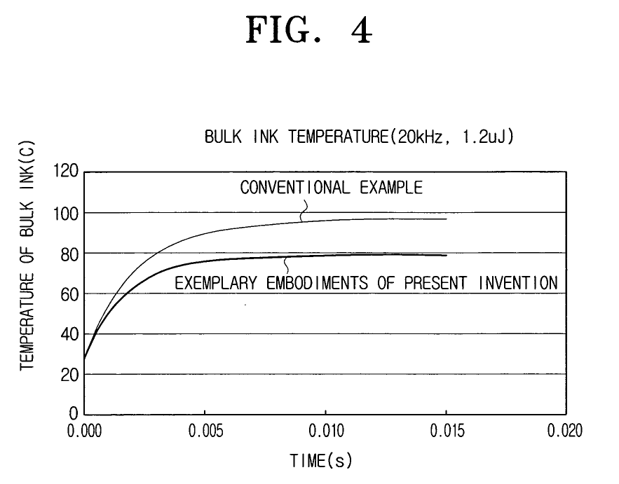

FIG. 4 is a graph exemplifying a comparison of the results between a mean temperature of bulk ink embodied by the print head according to exemplary embodiments of the present invention and that embodied by the conventional print head. The bulk ink means ink contained in the ink chamber.

As illustrated in FIG. 4, it may be appreciated that with the passage of time, an overheating temperature stands at approximately 97° C. in the bulk ink of the conventional print head, but approximately 80° C. in the bulk ink of the print head according to exemplary embodiments of the present invention, so that the print head according to exemplary embodiments of the present invention obtains a temperature decreasing effect of approximately 18° C.

Thus, it may be appreciated that with the insulating layer 220 having uneven thickness, the print head according to exemplary embodiments of the present invention maximally restrains the heat generated from the heat transmitting part 232 of the heater layer 230 from being excessively transmitted to the ink chamber 270.

As apparent from the foregoing description, according to the exemplary embodiments of the present invention, the print head and the fabrication method thereof enhance the energy efficiency of the heater layer and substantially prevent the heat from being excessively transmitted to the ink chamber, thereby improving the ink-ejecting performance and/or the printing performance.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A print head, comprising:
a substrate having an ink chamber and a nozzle disposed in the top thereof;
an insulating layer layered on the substrate; and
a heater layer layered on the insulating layer, and having a heat transmitting part to transmit heat to the ink chamber,
wherein the insulating layer has a non-uniform thickness.

2. The print head of claim 1, wherein the insulating layer is formed so that a portion thereof that faces the heat transmitting part has a thickness larger than that of a remaining portion of the insulating layer.

3. The print head of claim 1, wherein the heater layer is formed so that the heat transmitting part has a height different than that of another portion of the heater layer.

4. The print head of claim 1, wherein the heater layer is formed so that the heat transmitting part has substantially the same height as that of another portion of the heater layer.

5. The print head of claim 1, wherein the insulating layer has a raised floor formed on a portion thereof that faces the heat transmitting part.

6. A print head, comprising:
a substrate;
a chamber layer disposed at the upper side of the substrate, and having an ink chamber;
an insulating layer layered on the substrate;
a heater layer layered on the insulating layer, and having a heat transmitting part;
a wire layer layered on the heater layer to apply current to the heater layer; and
a protecting layer layered on the wire layer and the heater layer,
wherein the insulating layer has a non-uniform thickness.

7. The print head of claim 6, wherein the insulating layer is formed so that a portion thereof that faces the heat transmitting part has a thickness larger than that of a remaining portion of the insulating layer.

8. The print head of claim 6, wherein the heater layer is formed so that the heat transmitting part has a height different than that of another portion of the heater layer.

9. The print head of claim 6, wherein the heater layer is formed so that the heat transmitting part has substantially the same height as that of another portion of the heater layer.

10. The print head of claim 6, wherein the insulating layer has a raised floor formed on a portion thereof that faces the heat transmitting part.

11. A method of fabricating a print head, comprising the steps of
forming an insulating layer having a non-uniform thickness on a substrate; and
forming a heater layer on the insulating layer after the insulating layer is formed on the substrate.

12. The fabrication method of claim 11, wherein the insulating layer is formed so that a portion thereof that faces a heat transmitting part of the heater layer has a thickness larger than that of a remaining portion of the insulating layer.

13. The fabrication method of claim 11, wherein the heater layer is formed so that the heat transmitting part has a height different than that of another portion of the heater layer.

14. The fabrication method of claim 11, wherein the heater layer is formed so that the heat transmitting part has the same height as that of another portion of the heater layer.

15. A print head, comprising:
a substrate;
an ink chamber to store ink;
a nozzle to eject ink from the ink chamber;
an insulating layer having a non-uniform thickness layered on the substrate;
a heater layer layered on the insulating layer and having a heat transmitting part to transmit heat to the ink chamber and a current applying part to apply current to the heat transmitting part; and
a wire layer layered on the heater layer to apply current to the current applying part of the heater layer.

16. The print head of claim 15, wherein the insulating layer is formed so that a portion thereof that faces the heat transmitting part has a thickness larger than a portion of the insulating layer that faces the current applying part.

17. The print head of claim 15, wherein the heater layer is formed so that the heat transmitting part has a height different than that of the current applying part of the heater layer.

18. The print head of claim 15, wherein the heater layer is formed so that the heat transmitting part has substantially the same height as that of the current applying part of the heater layer.

19. The print head of claim 15, wherein the insulating layer has a raised floor formed on a portion thereof that faces the heat transmitting part.

20. The print head of claim 15, wherein a protecting layer is layered on the wire layer and the heater layer.
